(19) United States
(12) Patent Application Publication
(10) Pub. No.: US 2009/0030773 A1
(43) Pub. Date: Jan. 29, 2009

(54) Information Acquisition System

(76) Inventor: Ronald P.F. Kamhoot, Woodstock (ZA)

Correspondence Address: STITES & HARBISON PLLC, 1199 NORTH FAIRFAX STREET, SUITE 900, ALEXANDRIA, VA, 22314, US

(21) Appl. No.: 11/908,052

(22) PCT Filed: Mar. 10, 2006
(86) PCT No.: PCT/IB2006/050761

§ 371 Date: May 6, 2008

(30) Foreign Application Priority Data
Mar. 10, 2005 (ZA) 2005/02068

(51) Int. Cl. G06Q 30/00; G06Q 10/00

(52) U.S. Cl. 705/10; 705/26; 705/27

(57) ABSTRACT

An information acquisition system (10) includes a collection system (12) for collecting information relating to and/or from a target (30); a notification system (14) for notifying the target (30); a collaboration system (16) for collaborating with the target (30); and a data storage engine (18) for storing data relating to the target (30). The system can be used for at least one of the following functions: research and direct marketing; merchandise auditing; surveying the products in a store; merchandise ordering; market intelligence acquisition; sales representative management; and stock [symbol] taking. The functions are performed in real time. The target (30) is a customer or a store, including a retail store and/or a wholesale store. The information relates to products in a retail store or shop.

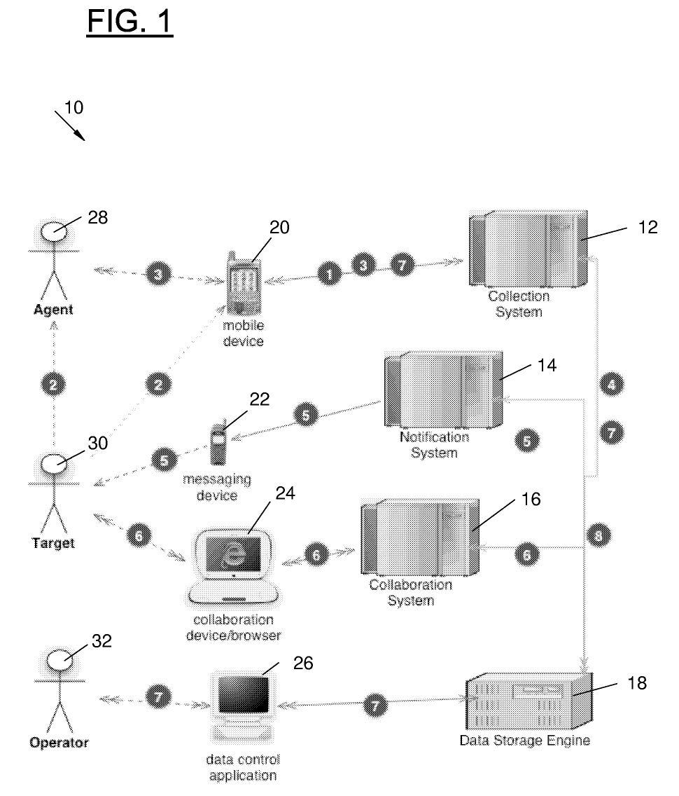

### FIELD OF INVENTION

The present invention relates to an information acquisition system.

### BACKGROUND TO INVENTION

In view of ever increasing competition in the market place and the need for customer satisfaction, marketing research, stock and re-order and marketing tools are required in the market place by companies. Present methods and systems are cumbersome, require extensive man-power, analyses of data, often resulting in delays and subsequent collection of data.

Presently sales representative activity involves calling on customers or retailers with the aim of merchandising and acquiring orders. These procedures are however difficult to manage and time-consuming, not only for the sales representative, but also the sales representative controller and the customers and retailers.

It is an object of the invention to suggest an information acquisition system which will assist in overcoming the afore-mentioned problems.

### SUMMARY OF INVENTION

According to the invention, an information acquisition system includes
(a) a collection system for collecting information relating to and/or from a target;
(b) a notification system for notifying the target;
(c) a collaboration system for collaborating with the target; and
(d) a data storage engine for storing at least data relating to the target.

The system may be used for at least one of the following functions:
(a) research and direct marketing;
(b) merchandising auditing;
(c) survey the products in a store;
(d) merchandising ordering;
(e) market intelligence acquisition;
(f) sales representative management; or
(g) stock-taking/out of stock/re-ordering.

The functions may be performed real-time.

The functions may include transmission, receipt and/or dissemination of data.

The target may be a customer, a store, including a retail store and/or a wholesale store.

The information may be related to products in a retail store or shop.

The collection (and/or delivery) system may be operated by a sales, merchandising and/or marketing representative.

The collection of information may occur within a store and/or shop.

The information may include opinions and/or product experience from the store's personnel and/or management.

The information may include photographs and/or videos of products and/or the location and display of products in a store and/or competitor products.

The notification system may include sending confirmations with respect to the function performed.

The confirmations may be sent via telefax, e-mail, SMS, telephonically, GPRS, 3G, WAP, the Internet and/or other electronic communication means.

The confirmations may be an order and/or merchandising confirmation.

The confirmations may be pro-forma orders generated by the sales representative to be confirmed by the store management.

The collection system may include a smartphone (a combined mobile phone and personal digital assistant (PDA)).

The system may include a mobile device for providing information from a target to the collection system and/or back end database.

The system may include a messaging device to assist the notification system.

The system may include a collaboration device to assist the collaboration system.

The system may include a data control application to assist an operator in operating the data and/or the storage engine.

An agent may facilitate the input of information of the target to the collection system.

The information of the target may include digital information including digital photographs and feedback on questions and other stimuli from the target.

The mobile device may be a mobile cell phone with digital camera, PDA, PDA & computer, laptop/notebook computer or strategically placed desktop computer with web browser.

The mobile device may be adapted to asynchronously or synchronously network to broadcast captured information to the collection system.

The mobile device may be adapted to retrieve information (configurations & software) from the collection system in order to present the target (via the agent) with specific questions, stock and re-orders and other stimuli.

The agent may assist the target to either directly (by capturing the required information on behalf of the target) or indirectly (by inviting the target to enter responses himself) give feedback on stimuli so that information is captured onto the mobile device.

The information captured may allow at a later stage the system to prompt the target and subsequently authenticate the target so that further interaction can take place.

The captured information may be transmitted to the collection system using mobile device specific networking protocols, including TCP/IP, WAP, SMS, MMS, IM, GPRS, G3, Edge, SMTP, HTTP, XML, WebServices, SOAP.

The collection system may receive the captured information and persists the data for future retrieval and further processing.

The collection system may be adapted, depending on the transport mechanism above, to utilise data queues and gateways including common email protocols (SMTP, POP3, IMAP), mobile phone messaging protocols (SMS, MMS), messaging gateways.

The data may be persisted utilising data storage engines including computer file systems and (relational) database management systems.

The notification system may retrieves (captured and other) information and sends an invitation message/notification to the target requesting interaction with the collaboration system.

The message/notification may be sent as a SMS to a mobile phone but could also be any other kind of (short) message (MMS, IM, email) send to a digital device capable of receiving and rendering such a message/notification, including a computer with an email client or Instant Messaging programme.

The type of message may be determined by the captured data.

The target may follow the instructions of the notification invite and interact with the collaboration system.

The interaction may be facilitated by a dynamic web application accessible by a common Internet (HTML) browser.

Interaction may also take place in the form of specially formatted SMS messages that can be interpreted by the collaboration system (e.g. the target responds with a simple “YES” or a “NO” SMS).

Interaction may also rely on call centres possibly utilizing IVR (Interactive Voice Recognition) systems.

The interaction may lead to the production and capturing of more information.

The operator may query data from the data storage engine.

Reports and data files may be extracted for further interpretation, analyses and processing to satisfy business processes and requirements.

The business processes may require the input of new data or the modification of existing data to be uploaded onto the mobile device via the collection system.

The above processes may repeat to satisfy continuous business objectives.

The research and direct marketing system may allow for the capture of market information dynamically, whilst in the field with cellular phone (GPRS) and PDA technology.

The information may be sent immediately to various databases, which in provide a market research value and simultaneous creates a database of that interviewee, providing a niche direct marketing value.

The invention may provide a system for both researching and capturing customer information in an integrated seamless manner using proven technologies.

### BRIEF DESCRIPTION OF DRAWING

The invention will now be described by way of example with reference to the accompanying schematic drawing.

In the drawing there is shown an information acquisition system in accordance with the invention.

### DETAILED DESCRIPTION OF DRAWING

Referring to the drawing, an information acquisition system in accordance with the invention, generally indicated by reference numeral 10, is shown.

An information acquisition system 10 includes
(a) a collection system 12;
(b) a notification system 14;
(c) a collaboration system 16;
(d) a data storage engine 18;
(e) a mobile device 20;
(f) a messaging device 22;
(g) a collaboration device 24; and
(h) a data control application 26.

In use an agent 28 (representative, sale representative, brand ambassador) empowers herself with the mobile device 20 adapted to capture digital information including but not limited to digital photographs and feedback on questions and other stimuli from a target 30.

The mobile device 20 can be anything from a mobile cell phone with digital camera, PDA, PDA & computer, laptop/notebook computer or strategically placed desktop computer with web browser.

The mobile device 20 is adapted to asynchronously or synchronously network to broadcast captured information to the collection system 12.

In more complex cases the mobile device 20 is adapted to retrieve information (configurations & software) from the collection system 12 in order to present the target 30 (via the agent 28) with specific questions and other stimuli.

The agent 28 facilitates/assists/engages the target 30 to either directly (by capturing the required information on behalf of the target 30) or indirectly (by inviting the target 30 to enter responses himself) give feedback on stimuli so that information is captured onto the mobile device 20.

The information captured would allow at a later stage the system 10 to prompt the target 30 and subsequently authenticate the target 30 so that further interaction can take place.

The captured information is transmitted to the collection system 12 using mobile device specific networking protocols, including but not limited to TCP/IP, WAP, SMS, MMS, IM, GPRS, G3, Edge, SMTP, HTTP, XML, WebServices, SOAP.

The collection system 12 receives the captured information and persists the data for future retrieval and further processing.

The collection system 12 is adapted, depending on the transport mechanism above, to utilise data queues and gateways including but not limited to common email protocols (SMTP, POP3, IMAP), mobile phone messaging protocols (SMS, MMS), messaging gateways.

The data is persisted utilising data storage engines 18 including but not limited to computer file systems and (relational) database management systems.

The notification system 14 retrieves (captured and other) information and sends an invitation message/notification to the target 30 requesting interaction with the collaboration system 16.

The message/notification is typically sent as a SMS to a mobile phone but could also be any other kind of (short) message (MMS, IM, email) send to a digital device capable of receiving and rendering such a message/notification, including but not limited to a computer with an email client or Instant Messaging programme.

The type of message is normally determined by the captured data.

The target 30 follows the instructions of the notification invite and interacts with the collaboration system 16.

The interaction is typically facilitated by a dynamic web application accessible by a common Internet (HTML) browser.

Interaction could also take place in the form of specially formatted SMS messages that can be interpreted by the collaboration system 16 (e.g. the target 30 responds with a simple “YES” or a “NO” SMS).

Interaction could also rely on call centres possibly utilizing IVR (Interactive Voice Recognition) systems.

This interaction leads to the production and capturing of more information. All relevant and required information is persisted to the data storage engine 18.

The operator 32 queries data from the data storage engine 1 8.

Reports and data files can be extracted for further interpretation, analyses and processing to satisfy business processes and requirements.

The business processes may require the input of new data or the modification of existing data to be uploaded onto the mobile device 20 via the collection system 12.

The above processes repeat to satisfy continuous business objectives.

The research and direct marketing system 10 in accordance with the invention is a value-added marketing tool, combining in the field market research together with simultaneous creation of a database specific to the market being canvassed.

The research and direct marketing system allows for the capture of market information dynamically, whilst in the field with cellphone (GPRS) and PDA technology.

This information is immediately sent to various databases, which in provide a market research value and simultaneous creates a database of that interviewee, providing a niche direct marketing value.

The invention provides a system for both researching and capturing customer information in an integrated seamless manner using proven technologies.

### EXAMPLE 1

Scenario: A Brand Customer Representative or Brand Ambassador meets with the target market in a social environment, for example ‘News Café’, whilst socialising with a group of people,

It is possible, with permission, to canvas individuals to be part of the “Lucky Strike Club”.

This has certain status value and allows access to private concerts, free give-aways, etc.

The invention performs two complementary functions simultaneously,
1. it canvas's market research from the interviewee and
2. captures that person into a database, for niche direct market value.

For example:
1. Do you smoke?
2. What do you smoke?
3. Have you tried Lucky Strike?
4. What do you think of Lucky Strike's new packaging?

Question Type:
1. Yes/No
2. Lucky Strike, Camel, B&H, etc (drop down menu choice)
3. Yes/No
4. Rating 0%(dislike)-100%(fantastic)

The above scenario covers 4 questions, yet it immediately provides accurate market feedback on

New packaging acceptance into market

Determines who smoke

Provides consideration to Lucky Strike.

Upon completion of the short market research, the interviewee's information is captured by
5. photograph direct from cell phone/pda &
6. personal cellular phone number (both provided voluntary)

This information, together with market research is sent dynamically in real-time to the research and direct marketing system backend, which

analyses this information

publishes this information securely via web access

Reported across the aggregate of the market research sample and also linked to the specific interview.

Simultaneously, the interviewee's photograph & cell number

Is automatically placed within their unique page within a customer database.

A unique customer identification number is generated linked to this page,

(Welcome to the Lucky Strike Club: id 23×w56:luckystrike.com)

A sms is sent automatically containing this unique id number & a web site address

The interviewee is incentivised to access the website, where upon input of the unique id, gains access to their unique page with their photograph, where they then fill in more information, thus growing the unique customer data for research purpose, they in turn are exposed to the marketing effort & benefits. This information may be captured globally and results available immediately for analysis, anywhere in the world.

The key benefits of the Information acquisition system 10 in accordance with the invention which is used for sales representatives are the following:
market intelligence from the field in order to improve product and service delivery;
merchandising feedback to insure brand consistency and stock holdings; and
a more efficient method of order capture.

Whilst traditional sales representative activity involves calling on customers and achieving orders, the methodology is difficult to manage and time-consuming. The invention thus allows value efficiencies in a simple techware offering.

For example, a representative from Bco calls on a store stocking his company's products:

Equipped with a smartphone (combination of a cellular phone & personal digital assistant, PDA) the sales representative begins the client call with a brief market research questionnaire: the store buyer's opinion on service levels and product stock & delivery. Thus a real time market intelligence, merchandising audit and order solution is provided.

The value of market intelligence includes real-time customer feedback to management, namely The instore survey is immediately sent via the smartphone's GPRS seamlessly and is instantly available to management via a secure web browser.

The value of merchandising audit includes real-time product display audit feedback to management—namely merchandising stock on display with the latest Point of Sale material & product is traditionally part of a rep's duties, yet difficult for management to control with brand consistency and effort.

Upon the rep completing the merchandising task, using the smartphone's camera, a photograph/video is taken of the product display, transmitted immediately and is instantly available to management via a secure web browser. Real-time merchandising audit with date and time stamp linked to customer code is achieved.

The value of optional customized solution improves the traditional method whereby most orders are taken via pen & paper, called in and confirmed via fax. Using the smartphone, the representative may capture an order, against the customer code & a fax confirmation will be sent in real-time for buyer sign-off whilst with the customer.

This optional module is the ordering functionality allows products to ordered according to categories. The completion of the order automatically generates a fax that is sent directly to the customer who signs the order and returns it via fax to Bco head office. The real time ordering system can still based on traditional ordering systems to ensure that users are comfortable with the process.

The benefits of the invention for management are:
Smartphones are readily available and are offered by mobile phone operators with business contracts, enabling the ‘ownership’ of representative telephone numbers.
Secure, cost-efficient, nationwide & international, reliable techware. (smartphone & integrated software)
Real-time market intelligence
Real-time audit of merchandising
Nationwide and/or internationally
Real-time order methodology option

The invention thus provides a methodology for both the management of remote sales team and business efficiencies—capturing customer data in an integrated seamless manner using proven technologies and is unique in its field of endeavour.

The research and direct marketing system thus focuses on
(a) technology improvements: allowing more cost effective use of previously expensive technologies;
(b) changing customer attitudes: the emergence of niche channel marketing; and
(c) opportunities in existing markets: legislative restrictions growing innovative marketing opportunities

According to a further aspect of the invention, the target 30 can be a customer, a store, including a retail store or a wholesale store.

The information can relate to products in a retail store or shop. The collection system 12 can be operated by a sales representative and within a store or shop.

The information includes opinions and product experience from the store's personnel and management. The information includes photographs of products and the location and display of products in a store.

The notification system 14 includes sending confirmations with respect to the function performed.

The confirmations can be sent via telefax, e-mail, SMS, telephonically and the Internet and may include an order and merchandising confirmation, such as pro-forma orders generated by the sales representative to be confirmed by the store management.

The information acquisition system 10 in accordance with the invention can thus be used for at least one of the following functions, which can be performed real-time:
(a) research and direct marketing;
(b) merchandising auditing;
(c) survey the products in a store;
(d) merchandising ordering;
(e) market intelligence acquisition;
(f) sales representative management; and
(g) stock-taking.

### EXAMPLE 2

Two compiled Java modules run on a dedicated Linux server. These consist of a configuration suite—to manage records in a database—and survey builder—to create XML files representing question and answer sets. The records and files are uploaded to mobile devices.

For each customer an add/edit/publish functions for the following data is provided:
Modules and subscription packages
Company information (survey owner) and contact details
Supplier details
Retailer/customer details
Customer categories
Regions and locations
Management staff details
Sales staff details (reps)
Sales & marketing activities
Staff roles
Admin access rights
Catalogues
Product categories and sub-categories
Products
Unit of measure
Images
Mobile devices

Relationships exist between:
Survey owner and subscription packages
Managers and the staff they manage
Staff and roles within the business
Roles and access rights
Customers and their account managers
Sales staff and their regions
Sales staff, activities and customers
Customers and catalogues
Catalogues and products
Customers and products (orders)
Staff and mobile devices

All administration takes place on a dedicated server via a secure administration suite.

Survey questions are defined in XML and interpreted by the mobile application, thus separating the application from the data. The XML files are built in the administration back-end. The survey builder wizard creates:
1 or more forms consisting of:
A descriptive title
1 or more question/answer pairs
A question will consist of a text line
A selectable answer in the form of:
One or more check-boxes (yes/no)
Or radio buttons (multi-choice)
Or a drop-down selection set
Or a text field
A submit/save/ok button

The forms are built by the mobile application using the XML file and a pre-defined style sheet.

There is no data validation but all fields will be mandatory

The results are added to an XML file on the mobile device

Applications running on the mobile device are accessed via a list of menu items.

These items are determined by the subscription packages. Applications manage:
1. Communication
2. Configuration
3. Stock control
4. Surveys
5. Image capture
6. Orders

The communication suite manages the uploading of records and survey data to the phone and the downloading from the phone of updated records (stock levels and orders), survey results and images.

Configuration on the mobile device consists of selecting the customer being visited. The start of each activity is time-stamped. The staff member running the activity is retrieved via the mobile device's ID. The list of menu items is determined by the customer profile.

Stock Control/Ordering has Two ‘Modes’:
(a) Update stock levels allow staff to select a product from the customer's catalogue. For each product a current stock level is captured. The form used for this has a drop-down list of stock items and an entry field for a numeric value and an optional unit of measure (single, carton of 6, case of 144 etc.). Two buttons ‘capture new’ and ‘done’ control the looping. If done is chosen the stock levels are displayed and if correct an OK button saves the contents for later synchronization with the server. An ‘edit’ button loops through the item list allowing stock levels already captured to be changed.
(b) The order mode first allows the user to filter products by low stock levels to facilitate re-ordering. For each product selected, an order amount and unit of measure is required. These items are added to a shopping cart. Two buttons ‘capture new’ and ‘done’ controls the looping. Once the ‘done’ button is clicked a summary screen of all items in the cart is displayed. If the order is correct an OK will save the contents for later synchronization with the server. An ‘edit’ button loops through the item list allowing quantities and UoMs to be changed.

Surveys are designed on the administration server, uploaded to the mobile device and incorporated into the list of menu items. A quality assessment forms part of the merchandising revue and a customer survey is completed as the final step before leaving the store. The results of the survey are stored in a XML file and uploaded to the server. Surveys run through all the forms, displaying the questions from the file and requiring answers in their relevant format.

When image capture is chosen the J2ME application makes a system call to the device camera. The image is added to an email as an attachment and sent via SMTP to the email address assigned to the owner.

IBM's WebSphere Micro Environment, a Java 2 Micro Environment runtime, is licensed and makes use of MIDlets (Java applications) to run on the Palm OS. The code may be recompiled to run on the Windows Mobile OS.

Java 2 Platform Micro Edition is the version of Java specifically designed for consumer and embedded devices such as PDAs and mobile phones. J2ME uses the same language and tools as the desktop (J2SE) and server (J2ME) versions of Java, but with a reduced set of Application Programming Interfaces (APIs). With Java support on Palm devices, Java architectures and even code can be shared and extended across all tiers of an end-to-end solution.

The J2ME platform defines the configurations, profiles, and packages that embody a runtime environment. The most suitable runtime environment is IBM's WebSphere Micro Environment J2ME. The IBM runtime enables support for the industry standard Connected Limited Device Configuration (CLDC) and Mobile Information Device Profile (MIDP), which form the core of J2ME. The environment is tested against and complies with the Sun Technology Compatibility Kits (TCK), the standard test suite used to certify a Java environment.

A development setup that is capable of producing J2ME-compliant MIDlet Suite applications in the JAD and JAR file formats is used. The WME Developer Toolkit for Palm OS (PDT) transforms a J2ME MIDlet Suite's JAD and JAR files into PRC format, ready for execution on a Palm Powered device by WME. This toolkit is incorporated into the build environments, through use of the Ant scripting tools.

Sun ONE Studio 4 update 1 is the latest release in the Sun ONE Studio line of IDEs for Java technology developers. It is based on the NetBeans Tools Platform and provides the latest support for Java and Industry Standards in the development of enterprise-class applications and Web services.

The J2ME Wireless Toolkit is a set of utilities and tools for creating J2ME applications from the command line. A simple toolbar interface is available to help drive these command line tools, but this is not a full featured IDE. However, it's an invaluable tool regardless of which development environment you prefer, as it provides emulation for various phone devices, and includes lots of very good sample code.

Palm OS applications distributed in Palm Resource (PRC) format may be installed using a HotSync operation, which copies the PRC file to the Palm OS device, by beaming them from one device to another.

Java 2 Micro Edition (J2ME) typically doesn't have a desktop synchronization feature that can be used to install applications. However, these devices have built-in wireless data capabilities, so a model may be developed that relied upon “Over-The-Air” (OTA) provisioning as the primary means for installing and managing applications or we can upload them directly to the device using a web browser or email program.

OTA defines an on-device sandbox security model that relies upon cryptographic signing of applications and granting explicit permissions to perform various functions deemed to be sensitive. The end result is a system that is designed to allow content distribution while protecting the security and reliability of the network, the user's device, and the phone itself.

Java applications can be converted into PRC files, and given all the rights and capabilities of a first-class “native” Palm OS application. Any MIDlets provisioned to the device via a HotSync operation must be converted to a PRC before provisioning.

Java applications can also be maintained in their original Java Archive (JAR) format, and provisioning using the OTA model through a wireless connection and web browser, in the exact same manner as you would on a mobile phone.

The OTA model that supports the JAR format provides a fairly robust security model, enabling trust in both provisioning and execution of applications. Signing a JAR file enables the Java Application Manager on the Palm OS device to verify the content of the downloaded application to ensure that it wasn't modified, and that a trusted authority has verified the identity of the author or developer of the application. This process is similar to that used to provide secure transactions with web servers when using a browser on a desktop computer.

Once the application is on the device, it must be granted permission to perform operations like accessing the network, opening a local serial port, or even reading and writing databases.

A Java Archive Descriptor (JAD) file is required to provide a small amount of metadata about the application.

The MIDlets in JAD+JAR format are distributed, since PRC is a Palm OS specific format. Applications distributed only in JAD+JAR format must be installed by downloading them on the device. This is done via a website using http. In future upgrades one can consider making the applications available in PRC format. Even though the PRC version won't benefit from the OTA security model, clients may HotSync in the offices, improving security and verion control.

During the development cycle the MIDlet is run on a Simulator. Once debugged test applications are further uploaded to a Palm OS device.

The WebSphere Micro Environment Toolkit for Palm OS Developers to debug all applications is used.

IBM WebSphere Micro Environment supports JSR 75 (PDA Optional Extensions) and JSR 172 (Web Services).

WebSphere Micro Environment is designed to have access to the entire dynamic and storage heap currently available on a Palm Powered device. I.e. on a Treo 600 smartphone this means up to a 3 MB dynamic heap, and up to 32 MB of storage heap. A Tungsten C handheld has up to a 4 MB heap, and up to 51 MB of usable storage heap.

The Java technology implementation provided by PalmSource and IBM is designed to conform to all the appropriate standards established for J2ME. WebSphere Micro Environment for Palm OS® implements the following specifications:
(a) Connected Limited Device Configuration (CLDC) 1.1

The Connected Limited Device Configuration (CLDC) provides the core non-GUI and database-related APIs that Java 2 Micro Edition uses. Most of these classes and methods correspond to existing functionality in the Palm OS platform. Subsets of the expected java.lang, java.util, and java.io classes are available. With CLDC 1.0 the “float” primitive, along with associated math functions and object wrapper were not available. CLDC 1.1 is used.

CLDC also provides the connection framework within the javax.microedition.io package. This connection framework is the foundation for datagram- and stream-based connections. The MIDP library actually provides the various common implementations with this framework.
(b) Mobile Information Device Profile (MIDP) 2.0

The Mobile Information Device Profile (MIDP) is designed to extend the CLDC. MIDP 1.0 includes APIs for networking, user interfaces, local persistence, and MIDlet life-cycle. MIDP 2.0 improves upon the MIDP 1.0 significantly with enhanced user interface, multimedia and game APIs, greater connectivity, over-the-air (OTA) provisioning, and end-to-end security. MIDP 2.0 is backward compatible with MIDP 1.0. MIDP 2.0 is used.

MIDP is designed to provide the high-level functions required by modern applications, including the definition of the basic application unit—in this case, the MIDlet. A MIDlet is similar to a traditional Java applet, which is downloaded from a website by a browser, and executes within a secured J2SE sandbox.

A MIDlet suite maps directly to a Palm OS application, with each MIDlet suite being represented on the launcher and assigned a creator ID, just like a Palm OS application. The first screen that is displayed is the MIDlet chooser, listing the name of each MIDlet in the suite, and allowing the user to pick which one to run. If there is only one MIDlet in a suite, that MIDlet is always executed by default. A MIDlet suite with one MIDlet is the best implementation of a J2ME application on the Palm OS platform and mimics a native Palm OS application.

The javax.microedition.lcdui API is designed to implement form and canvas-based GUI components. A Forms model is used, with type-validating TextField, Images, Choice Groups, Scrollers, and more, to implement surveys using a blank Canvas subclass. Also included is support for five-way navigation control, keyboard, and stylus on devices that support those features, as well as all other hardware buttons on the device. The Forms implementation provides for a look and feel that is compatible with the standard Palm OS user interface, leveraging its proven usability and functionality.

The Record Management System (RMS) package: javax.microedition.rms enables persistence of data locally on the device through simple record-style methods, and is implemented on top of the Palm OS Data Manager API.

The MIDP 2.0 release supports the Portable Network Graphics (PNG) format for graphics. Color depth is up to 16-bit and transparency is supported.

MIDP on WebSphere Micro Environment allows implement connectors utilizing the General Connection Framework provided by the CLDC implementation. These include HTTP and HTTP/S connectors for standard communication between WebSphere Micro Environment MIDlets and remote Web or application servers.

The WebSphere Micro Environment Toolkit for Palm OS provides two components for use by developers with any J2ME compliant development environment. The JarToPRC tool takes a MIDP-compliant JAD and JAR file, and allows the developer to output a Palm OS PRC file with Palm-style naming and icons. This means J2ME MIDlet Suites can look to an end-user just like an normal Palm OS application.

The Xora Offline framework allows developers to build and deploy intelligent client applications for use in occasionally connected environments. The Offline framework consists of the Offline client and the Offline server. The Offline framework supports J2MEapplication environments. With the intelligent Offline client on the device, mobile users can operate seamlessly between areas of wireless coverage and dead spots. The offline client automatically detects coverage and performs a two-way synchronization between the handheld device and the enterprise application server.

Aligo offers a suite of award-winning mobile business solutions designed to provide mobile workers with always-available access to applications and data from any location and from any device, even without wireless connectivity

PointBase Micro is a platform-independent Java relational database optimized to run on the J2ME CDC and CLDC/MIDP and J2SE platforms. It has an ultra-compact footprint (<45K for J2ME MIDP) and can be easily embedded within a Java application, making it transparent to users from the time of deployment.

An IDE is required for developing Java MIDlets for Palm OS. We believe IBM's WebSphere Studio Device Developer 5.7 will suffice. The WebSphere Micro Environment Palm Developer Toolkit can be integrated into other tools through build scripts (i.e. using ANT), and through use of the included debugger proxy, which allows a third-party.

The latest release of WebSphere Micro Environment for Palm OS supports MIDP 2.0 and CLDC 1.1, and is a Native ARM runtime executable. Sun's MIDP for Palm OS is a 68 k or PACE application (runs on ARM through emulation) and only supports MIDP 1.0 and CDLC 1.0 at a low resolution

Http (upload via browser) will be used and smtp (email) to load applications and XML data onto PDAs. Alternatives that may be considered are:
1. use products that enable synchronization of data from mobile J2ME clients to enterprise servers. These include IBM's DB2 Everyplace and MQSeries Everyplace components, PointBase Micro, and Aligo's Omni Mobile Platform.
2. utilize HTTPS to send and receive XML data (either in HTML or SOAP form) from any enterprise server available on the internet.
3. utilize built-in or third-party VPN services on Palm OS devices, you can further secure access to that data.
4. Use open-source KSOAP and KXML libraries to build applications that utilize SOAP and XML for Web Services.

These synchronization protocols and services assume always-on connectivity so we will require a connection and synchronization management suite such as Xora Offline framework (see above) to utilize these technologies.

HTTP over SSL is supported by the HTTPS Connector. This utilizes the underlying RSA SSL Library provided by Palm OS. All application signing functions required by MIDP 2.0 are implemented.

### EXAMPLE 3

The system entails the lease or purchase of a SmartPhone for each of the Sales representatives. A customised application is installed on each device by ISS which allows for more efficient operation of sales reps at customer premises with immediate and more detailed information of these operations relayed to management.

Smartphones are a combination of a cell phone and a Personal Digital Assistant (PDA). These phones need to be GPRS-enabled for the transfer of data.

SmartRep is an integrated solution with a software application uploaded onto a Smart Phone and backend technology running on independent secure servers. The information, once collected is ‘pushed’ via e-mail to the Customer desktop. No intervention is required within customer's enterprise solution (SAP).

The application, or any revisions to it, is simply broadcast via email to all Smart Phones and uploaded.

User Specifications SmartRep adds value to the Sales Effort in the following integrated manner
(a) Management Information
(b) Merchandising Audit
(c) Market Intelligence
(d) Processing Orders
(e) Quality Assessment

Management Information
Information entered into the Smartphone is immediately available to management.
Real-time access to this information enhances decision-making.
Management is better able to monitor sales rep activity, again in real-time.
Trend and comparative analysis reports are automatically ‘pushed’ within pre-determined sales cycles.
Real time audit trail of activity against location.

Merchandising Audit
Reps can use the onboard camera to capture visual images of instore merchandising, branding, competitive product.
Images are location-specific and time- and date-stamped.
Images are immediately transmitted to backend and may be viewed immediately by management
Or tracked in database over sales cycle.
Merchandising Audit allows management to ‘visit all customer locations, virtually, daily.
Capture of existing stock levels

Market Intelligence
Market information can be captured from clients or shoppers and transmitted immediately to management.
A standard customer-satisfaction survey is included in the SmartRep application.

Order Capture
Reps can input sales orders into a customised SmartRep order component to immediately transmit orders to their specific tele-sales assistant.
The order can then be confirmed by fax or email.
Orders are therefore inputted only once.
This option offers faster and more reliable processing of orders.
Stock levels captured are visible in order sheet

Quality Assessment
Reps can capture quality issues via pre-determined questions and drop-down multiple choice options
MI solution component
Transmitted to stand-alone data-base
Data mining accessability

Work-Flow

The invention is an integrated solution, made up by various components, that are activated either in a random manner or follow a work=flow process).
(a) Activate Solution (Branded & customised “Welcome Rene Jongkind)
enter location
(pre-determined per rep (1 of 9 reps) & text capture option)
work flow choice of graphical icons
(transmits an audit trail start)
(b) Quality Assessment
(c) Merchandising Audit
(d) Customer Insight Survey
(e) Order Capture

Quality Assessment

A set of questions determining the product quality in fridge

Transmit upon completion (location/date/time stamp)

Merchandising Audit

Stock on hand count & units inputted

Photographic proof

Transmit upon completion (location/date/time stamp)

Customer Insight Survey

A set of questions determining customer perception of service, delivery, price, etc

Order Capture

Pre-load order sheet with stock on hand

Choose additional order items transmit upon completion (location/date/time stamp)

Close Solution

All data per location saved to SmartPhone, schedule transmission with server side verification of receipt of transmitted data.

### LIST OF REFERENCE NUMERALS

10 Information acquisition system
12 Collection system
14 Notification system
16 Collaboration system
18 Data storage engine
20 Mobile device
22 Messaging device
24 Collaboration device/browser
26 Data control application
28 Agent/Representative
30 Target
32 Operator

1. An information acquisition system for real-time business representative tracking, for capturing market information dynamically, for conducting market research, for capturing stock levels and for product ordering, which includes
(a) at least one mobile device associated with at least one business representative, the mobile device being adapted to collect information relating to at least one selected from the group consisting of products and/or services of the business real-time and remotely onsite at premises of the business;
(b) a collection system being adapted to receive and process the information from the mobile device(s),
(c) a data system being adapted to receive information from the collection system, to store the Information as data, and to retrieve at least one selected from the group consisting of the information and data for at least one selected from the group consisting of further processing and analyzing, the data system including at least one selected from the group consisting of data storage engines, computer tile systems and database management systems;
(d) a notification system associated with the collection system and the data system which Is adapted to send real-time at least one selected from the group consisting of confirmations, reports and data analysis relating to at least one selected from the group consisting of the information and data to at least one user of the business accessing the information acquisition system; and
(e) data control application being adapted to assist the user to perform at least one function selected from the group consisting of to operate, manage and analyze the data acquisition system and the associated data and information;
the system being adapted to enable the mobile device(s) to log-on to the collection system and retrieve at least one selected from the group consistinlof information, configurations and software from at least one selected from the group consisting of the collection system and the data system to assist the mobile device(s) to update at least one selected from the group consisting of data and software on the mobile device(s) and to assist the mobile device(s) collect the information relating to at least one selected from the group consisting of the products, services, the configurations, software market research questions, product and service data, and re-ordering data;
the system being adapted to allow the user to perform at least one functon selected from the group consisting of extract data and create reports relating to the collected Information;
at least one selected from the group consisting of the collected information, processed information, data and reports being adapted to be analyzed, to provide the business with real-time market research information, business representative tracking information including business representative location; and
the system being adapted to enable the mobile device(s) to capture at least one selected from the guconsisting of actual product and actual service quantities onsite at the premises and to generate orders for at least one selectd from the group consisting of merchandising, products andy services to be supplied by the business to the premises.

2. A system as claimed in claim 1, which is adapted to be used for at least one of the functions selected from the group consisting of:
(a) auditing of merchandise;
(b) surveying of at least one selected from the group consisting of products and services;
(c) ordering of merchandise and/or products
(d) acquisition of market intelligence;
(e) managing of sales representatives; and
(f) stock-taking.

3. A system as claimed in claim 1, in which all functions are performed real-time.

4. A system as claimed in claim 1, in which the premises is at least one selected from the group consisting of a store, a retail store and a wholesale store.

5. A system as claimed in claim 1, in which the information includes at east one selected from te group consisting of opinions, product experience from customers, personnel and, management of the premises.

6. A system as claimed in claim 1, in which the information includes at least one selected from the group consisting of photographs and videos of at east one selected from the group consisting of products, location of products and display of products.

7. A system as claimed in claim 1, in which the confirmations, reports orders are sent via at least one selected from the group consisting of telefax, e-mail; SMS, telephonically, GPRS; 3G; WAP, and the internet.

8. A system as claimed in claim 1, in which the orders generated by the mobile device(s) are at least one selected from the group consisting of adapted to be confirmed andy adapted to be transmitted to at least one selected from-the-gro consisfim of a tele-sales call centre and a sales office associated with the business.

9. A system as claimed in claim 1, in which the mobile device is a smartphone (a combined mobile phone and personal digital assistant (PDA)).

10. A system as claimed in claim 1, which includes a messaging device to assist the system in communicating messages.

11. A system as claimed in claim 1, in which the business representative facilitates at least one selected from the group consisting of the input and collection of information by the mobile device(s) at at least one selected from the group consisting of the premises, from a customer at the premises, personnel and management of the premises.

12. A system as claimed in claim 1, in which the information includes at least one selected from the group consisting of digital information, digital photographs and/or feedback on questions.

13. A system as claimed in claim 1, in which the mobile device(s) includes a mobile cell phone with at least one selected from the group consisting of digital camera, PDA, PDA & computer, laptop/notebook computer and strategically placed desktop computer with web browser.

14. A system as claimed in claim 1, in which the mobile device(s) is(are) adapted to asynchronously or synchronously network to broadcast captured Information to the collection system.

15. A system as claimed in claim 1, in which the business representative assists at least one selected from the group consisting of a customer, personnel and management of the premises to either directly by capturing the required information on behalf of the target or indirectly by inviting the target to enter responses himself give feedback on stimuli or questions so that information is captured onto the mobile device(s).

16. A system as claimed in claim 12, which is adapted to perform at least one function selected from the group consisting of prompt, interact and communicate directly with at least one selected from the group consisting of the customers, personnel, management of the store and a, communication device of at least one selected from the group consisting of the customer, personnel, management of the premises.

17. A system as claimed in claim 1, in which the information or data 15 transmitted using mobile device specific networking protocols, including TCP/IP, WAP, SMS, MMS, IM, GPRS, G3, Edge, SMTP, HTTP, XML, WebServlces, SOAP.

18. A system as claimed in a claim 1, which is adapted to utilize data queues and gateways including at least one selected from the group consisting of common email protocols (SMTP, POP3, IMAP), mobile phone messaging protocols (SMS, MMS), and messaging gateways.

19. A system as claimed in claim 16, in which an invitation message/notification is transmitted to at least one selected from the group consisting of the customer, personnel, management of the store requesting interaction.

20. A system as claimed in claim 19, in which the message/notification is sent as at least one selected from the group consisting of SMS, MMS, Instant Messaging, and email.

21. A system as claimed in claim 19, in which the customer, personnel or management of the premises follows instructions of the message/notification in order to Interact with the data acquisition system.

22. A system as claimed in claim 21, in which interaction is facilitated by a dynamic web application accessible by a common Internet (HTML) browser.

23. (canceled)

24. (canceled)
